(19) United States
(12) Patent Application Publication
(10) Pub. No.: US 2009/0304938 A1
(43) Pub. Date: Dec. 10, 2009

(54) Polyisocyanate-Based Binder for Mineral Wool Products

(76) Inventors: Thorsten Gurke, Huldenberg (BE); Vincent Laneau, Leuven (BE); Dominicus Limerkens, Meeuwen-gruitrode (BE)

Correspondence Address: HUNTSMAN INTERNATIONAL LLC, LEGAL DEPARTMENT, 10003 WOODLOCH FOREST DRIVE, THE WOODLANDS, TX, 77380, US

(21) Appl. No.: 12/091,187

(22) PCT Filed: Sep. 25, 2006
(86) PCT No.: PCT/EP06/66688

§ 371 Date: Aug. 29, 2008

(30) Foreign Application Priority Data
Oct. 26, 2005 (EP) 05110007.1

(51) Int. Cl. B05D 3/02; C09D 175/00

(52) U.S. Cl. 427/387; 524/442; 106/287.25; 106/287.11; 106/287.1

(57) ABSTRACT

Binder for mineral fibers comprising an organic polyisocyanate and an aqueous alkali metal silicate solution.

The present invention relates to a composition suitable for use as a binder for mineral fibers, i.e. man made vitreous fibers (MMVF), for example glass slag or stone wool, i.e. mineral wool, a process for providing such a composition, a mineral wool product provided with such a binder and the use of said composition as a mineral fiber binder.

Mineral wool products generally comprise mineral fibers bonded together by a cured thermoset polymeric material. One or more streams of molten glass, slag or stone wool are drawn into fibers and blown into a forming chamber where they are deposited as a web onto a traveling conveyor. The fibers, while airborne in the forming chamber and while still hot are sprayed with a binder. The coated fibrous web is then transported from the chamber to a curing oven where heated air is blown through the mat to cure the binder and rigidly bond the mineral wool fibers together.

Phenol-formaldehyde binders are widely used in the mineral wool industry since they have a low viscosity in the uncured state, yet still form a rigid thermoset polymeric matrix for the mineral fibers when cured. However the use of phenol-formaldehyde binders is becoming increasingly undesirable due to the use and release of environmentally unfavorable chemicals during the process.

It is an object of the invention to provide a binder composition which has excellent binding and fire resistant properties and is acceptable from a use or labor hygiene point of view. An important advantage is that the binder presents no excessive ecological load on the environment.

Accordingly the present invention provides a binder for mineral wool comprising an organic polyisocyanate composition and an aqueous alkali metal silicate solution.

On applying or curing the binder according to the present invention no excess toxic materials are released into the environment. The binder is also excellent in restorability.

The alkali metal silicate works both as a cheap diluent and acts as a binder itself. It also acts as a catalyst for the polyurea reaction and improves the adhesion of the polyisocyanate-waterglass mixture on the fibers. The alkali metal silicate also reduces the flammability of the binder, which will help in achieving excellent fire performance of the final mineral fiber mats.

The polyisocyanate used in the present invention may comprise any number of polyisocyanates, including but not limited to, toluene diisocyanates (TDI), diphenylmethane diisocyanate (MDI)-type isocyanates, and prepolymers of these isocyanates. Preferably the polyisocyanate has at least one and preferably at least two aromatic rings in its structure, and is a liquid product. Polymeric isocyanates having a functionality greater than 2 are preferred.

The diphenylmethane diisocyanate (MDI) used in the present invention can be in the form of its 2,4′-, 2,2′- and 4,4′-isomers and mixtures thereof, the mixtures of diphenylmethane diisocyanates (MDI) and oligomers thereof known in the art as “crude” or polymeric MDI (polymethylene polyphenylene polyisocyanates) having an isocyanate functionality of greater than 2, or any of their derivatives having a urethane, isocyanurate, allophonate, biuret, uretonimine, uretdione and/or iminooxadiazinedione groups and mixtures of the same.

Examples of other suitable polyisocyanates are tolylene diisocyanate (TDI), hexamethylene diisocyanate (HMDI), isophorone diisocyanate (IPDI), butylene diisocyanate, trimethylhexamethylene diisocyanate, di(isocyanatocyclohexyl)methane, isocyanatomethyl-1,8-octane diisocyanate and tetramethylxylene diisocyanate (TMXDI).

Preferred polyisocyanates for the invention are the semi-prepolymers and prepolymers which may be obtained by reacting polyisocyanates with compounds containing isocyanate-reactive hydrogen atoms. Examples of compounds containing isocyanate-reactive hydrogen atoms include alcohols, glycols or even relatively high molecular weight polyether polyols and polyester polyols, mercaptans, carboxylic acids, amines, urea and amides. Particularly suitable prepolymers are reaction products of polyisocyanates with monohydric or polyhydric alcohols.

The prepolymers are prepared by conventional methods, e.g. by reacting polyhydroxyl compounds which have a molecular weight of from 400 to 5000, in particular mono- or polyhydroxyl polyethers, optionally mixed with polyhydric alcohols which have a molecular weight below 400, with excess quantities of polyisocyanates, for example aliphatic, cycloaliphatic, araliphatic, aromatic or heterocyclic polyisocyanates.

Given as examples of the polyether polyols are polyethylene glycol, polypropylene glycol, polypropylene glycol-ethylene glycol copolymer, polytetramethylene glycol, polyhexamethylene glycol, polyheptamethylene glycol, polydecamethylene glycol, and polyether polyols obtained by ring-opening copolymerization of alkylene oxides, such as ethylene oxide and/or propylene oxide, with isocyanate-reactive initiators of functionality 2 to 8.

Polyester diols obtained by reacting a polyhydric alcohol and a polybasic acid are given as examples of the polyester polyols. As examples of the polyhydric alcohol, ethylene glycol, polyethylene glycol, tetramethylene glycol, polytetramethylene glycol, 1,6-hexanediol, 3-methyl-1,5-pentanediol, 1,9-nonanediol, 2-methyl-1,8-octanediol, and the like can be given. As examples of the polybasic acid, phthalic acid, dimer acid, isophthalic acid, terephthalic acid, maleic acid, fumaric acid, adipic acid, sebacic acid, and the like can be given.

In a particularly preferred embodiment of the invention prepolymers are used as the polyisocyanate component having an average functionality of 2 to 2.9, preferably 2.1 to 2.7, a maximum viscosity of 6000 mPa s, and an isocyanate content of 6 to 31.5 wt %.

Since low amounts of resin have to be evenly distributed on a large surface area, the resin preferably is diluted in water, which also serves to cool the freshly spun fibers. Therefore it is preferred to modify the polyisocyanate to make it emulsifiable. Non-emulsifiable polyisocyanates can also be used if a fine and uniform dispersion of polyisocyanate is made in water by mechanical means.

Examples of such emulsifiable polyisocyanates are described in the following patent publications: EP 18061, EP 516361, GB 1523601, GB 1444933, GB 2018796, all incorporated herein by reference. Such emulsifiable polyisocyanates are commercially available from Huntsman under the trade names Suprasec 1042, Suprasec 2405, Suprasec 2408 and Suprasec 2419 (Suprasec is a trademark of Huntsman LLC).

Preferred polyisocyanates to be used in the present invention are MDI-based including derivatives of MDI such as uretonimine-modified MDI, and MDI prepolymers, in particular emulsifiable MDI.

These polyisocyanates typically have an NCO content of from 5 to 33.6 wt %, preferably 10 to 31.5 wt % and a viscosity of between 50 and 5000 mPa.s, preferably 150 to 2000 mPa.s.

The commercially available aqueous alkali metal silicates, normally known as “waterglass” have been found to give satisfactory results in the binder composition of the present invention. Such silicates can be represented as M₂O.SiO₂ where M represents an atom of an alkali metal and they differ in the ratio of M₂O:SiO₂.

It has been found that the sodium silicates are highly satisfactory and while the other alkali metal silicates, e.g. potassium and lithium silicates may be used they are less preferable on economic and performance grounds. Mixtures of sodium silicates and potassium silicates can be used as well; in such cases the ratio Na₂O/K₂O is preferably 99.5:0.5 to 25:75.

The molar ratio M₂O to SiO₂ is not critical and may fluctuate within the usual limits, i.a. between 4 and 0.2. The preferred molar ratio SiO₂:M₂O is between 1.6 and 3.5, most preferably between 2 and 3.

Using the preferred sodium silicate, the SiO₂:Na₂O weight ratio may vary, for example, from 1.6:1 to 3.3:1. However it is found generally to be preferable to employ a silicate of which the said ratio is within the range 2:1 to 3.3:1.

The alkali metal silicate will preferably be sprayed onto the fibers as a solution in water. Therefore, the solution can be prepared from solid alkali metal silicates, or by diluting the commercially available aqueous alkali metal silicate solutions. These latter alkali metal silicate solutions preferably have a solids content from about 28 to 55% by weight, or have a viscosity of less than 3000 mPa.s, which is generally required for ease of handling. The concentration of the final solution can be adjusted according to the required amount of water needed for a sufficient wetting and cooling of the fibers. This concentration will typically be 5 to 15 wt % solids.

Examples of suitable commercially available waterglass is Crystal 0072, Crystal 0079, Crystal 0100 and Crystal 0100S (all Na based), available from INEOS Silicates and Metso 400 (K based), available from INEOS.

The relative proportions of the alkali metal silicate and the polyisocyanate should be adjusted such that the binder gives the right performance whilst still economically viable.

Typically the weight ratio between polyisocyanate and alkali metal silicate is between 95:5 and 20:80, most preferably between 85:15 and 50:50. This is equivalent to a weight ratio between polyisocyanate and waterglass of between 80:20 and 20:80, preferably 70:30 to 50:50. It was found that the latter ratios are specifically advantageous (and especially a ratio of about 2:1).

Isocyanate-reactive species such as polyols and amines can be added to the binder composition of the present invention. These compounds can be added in emulsion or solution with the alkali metal silicate, or applied separately, or mixed in just before spraying of the binder on the fibers.

The activity of the reaction mixture may be adjusted both through the isocyanate-silicate ratio and by using catalysts. Examples of suitable catalysts are those known per se, including tertiary amines, such as triethyl-, tripropyl-, tributyl- and triamylamine, N-methyl morpholine, N,N-dimethyl cyclohexylamine, N,N-dimethyl benzylamine, 2-methyl imidazole, pyrimidine, dimethylaniline and triethylene diamine. Examples of tertiary amines containing isocyanate-reactive hydrogen atoms are triethanolamine and N,N-dimethyl ethanolamine. Other suitable catalysts are silaamines having carbon-silicon bonds and nitrogen-containing bases such as tetraalkyl ammonium hydroxides; alkali hydroxides, alkali phenolates and alkali alcoholates. According to the invention organo metallic compounds, especially organo tin compounds, may also be used as catalysts.

The catalysts are generally used in a quantity of from 0.001 to 10% by weight, based on the total binder formulation.

Another way to control the activity of the reaction mixture is by using components which can harden the alkali metal silicate. These compounds may also serve as secondary catalysts or accelerators. The hardening agents can be organic or inorganic. Inorganic setting agents include but are not limited to: calcium chloride, calcium hydroxide, bicarbonates, carbon dioxide, calcium oxide, calcium sulphate, zinc oxide, magnesium oxide, magnesium hydroxide, aluminium sulphate, phosphates, microfine cements, portland cement, mineral acids, calcium carbonate, Pozzolans and aluminates. Components that modify pH and are sources of divalent or multivalent metal cations also function as setting agents. Organic setting agents react with silicate to form silica gels through pH modification. These include but are not limited to: ethylacetate, dibasic esters, mono-, di- and triacetin, organic phosphates and alkylene carbonates.

Standard binding additives can improve the binder. Examples of such additives include: silanes to improve the adhesion on glass, stabilizers to prevent thermal or UV degradation and surface-active compounds. Fillers, such as clay, silicates, magnesium sulfate and pigments, such as titanium oxide, can also be applied, as well as hydrophobising agents such as silanes, fluorine compounds, oils, minerals and silicone oil (reactive or non reactive).

Although it is not required to use silanes to improve adhesion of the binder to the fibers, it was found advantageous to use silanes as additive to improve the miscibility of the polyisocyanate with the alkali metal silicate solution. Preferably amino-containing silanes are used, and most preferably the amino-silanes which are soluble in the alkali metal silicate.

The present binder composition may also be applied in combination with other binder compositions such as for instance phenol-formaldehyde resins, starch, modified starch, polysaccharides, fufural, acrylics, polyvinylalcohol, cellulose and carboxymethylcellulose.

The binder composition is preferably sprayed onto the fibers just after the spinning of the glass or stonemelt. A typical method of distributing the binder on the fibers is through one or more rings with spray nozzles positioned around the bundle of the spun fibers. Since the two components of the binder system will react upon mixing, the two components should be mixed at the spray nozzle or shortly before to prevent gelling or precipitating reactions. An emulsion of polyisocyanate in water can be prepared shortly before mixing the two components. Other non-isocyanate-reactive additives can be mixed in this emulsion at this stage. The concentration of the polyisocyanate emulsion and the concentration of the alkali metal silicate solution can be chosen such that efficient mixing is obtained when the two components are mixed together just before the spray nozzle. The amount of additional water used can be adjusted such that the fibers are cooled to the desired temperature by evaporation of water.

Since the emulsions obtained from mixtures of polyisocyanates and waterglass are highly viscous it is preferred to apply the two components of the binder composition (polyisocyanate and aqueous alkali metal silicate solution) separately onto the fibers, preferably through the use of separate spraying nozzles. The preferred order being the alkali metal silicate solution first, followed by the polyisocyanate; leading to higher strength of the mineral wool product. It is preferred that the polyisocyanate is emulsified in water to optimize the distribution of polyisocyanate on the fibers when sprayed. Other non-isocyanate-reactive additives can be mixed in this emulsion. Also the amount of additional water used can be adjusted such that the fibers are cooled to the desired temperature by evaporation of water.

Other additives commonly used in the manufacturing of mineral wool like dusting suppressants, colorants, odorants, fillers, etc. can be added separately or by mixing into one or more of the diluted binder streams.

It is, however, also possible to apply the binder emulsion to the wool in a subsequent step of the production of the insulating material, for example by spraying it on the primary web on the conveyor, or even at a later stage. It is also possible to apply an additional binder in such a separate and later stage, thus obtaining a material with improved resistance and/or strength. A further possibility is to distribute the binder on dry, cold fibers, e.g. by spraying.

During the curing step when hot air is blown through the mat to cure the binder, prior art binders can be displaced within the mineral wool fibers, resulting in a non-uniform distribution of the binder, specifically leading to less binder at the bottom of the mineral fiber blocks (i.e. the side of the block where the hot air is blown into the product) compared to the top thereof. Also during the curing, a large amount of the prior art resin may be lost leading to undesirably high emissions and a high binder loss.

The binder according to this invention, however, is self-curing and does not need high oven temperatures. According to an embodiment of this invention the mineral wool slab is pressed into the required thickness and shape without the need for additional heating. An added advantage hereby is that the distribution of the fibers in the slab is more uniform, as well as the distribution of the binder. It can still be advantageous to pass the mineral wool slab through an oven to evaporate remaining water and to accelerate the cure of the binder.

The raw materials for fibers composition can be converted to a melt in the conventional manner, for instance in a gas heated furnace or in an electric furnace or in a shaft or cupola furnace. The melt can be converted to fibers in the conventional manner, for instance by a spinning cup process or by a cascade rotor process.

Man made vitreous fibers (MMVF) are made from vitreous melt, such as of stone, slag, glass or other melts. The melt is formed by melting in a furnace a mineral composition having the desired analysis. This composition is generally formed by blending rocks or mineral to give the desired analysis.

The fibers can have any convenient fiber diameter and length. Generally the average fiber diameter is below 10 μm e.g. 5 μm. Usually a mineral wool product contains 1 to 20 wt % dry binder, preferably 1 to 15 wt %, most preferably 2 to 10 wt %. Usually the binder is added to the fibers just after fibersation of the melt. Generally the mineral wool product is in the form of a slab, sheet or other shaped article.

Products according to the invention may be formulated for any of the conventional purposes of MMV fibers, for instance, slabs, sheets, pipes or other shaped products that are to serve as thermal insulation, fire insulation and protection or noise reduction and regulation or as horticultural growing media.

The binder can also be used to coat the surface of either the fibers or one or more of the surfaces of the mineral wool product

The various aspects of this invention are illustrated, but not limited by the following examples.

### EXAMPLE 1

20 Grams of glass fibers were impregnated with an emulsion consisting of 63.6 g water, 1 gram sodium silicate solution with molar ratio 2.5 and 42.1% solids (commercially available as Crystal 0100S) and 1 g SUPRASEC 2408 (which is a prepolymer derived from MDI with an NCO-value of about 15 wt %). The wetted fibers were placed in an alumimium mould in an oven at 220° C. for 20 minutes. The fibers were then removed from the mould and left another 15 minutes in the oven to dry.

The resulting fiber mat recovered after compression. A recovery test was performed by compressing a sample of 5 cm thickness between 2 aluminium plates to a thickness of 2.5 cm for 16 hours at 50° C. and 80% relative humidity. The thickness was measured after 30 minutes recovery. The sample had only lost 1.3% of its original thickness.

### EXAMPLE 2

A surprising advantage was found in the addition order of the polyisocyanate composition versus the waterglass. It was found that adding the waterglass as a separate component first to the glass beads before adding the emulsified polyisocyanate gives better strength. This is shown in the following table.

A typical test to assess binder strength for mineral wool products was performed. Glass beads with a diameter of 0.1 to 0.2 mm were mixed with 3% resin. The binder was added as a 30% solution of the resin. In practice aout 582 g of glass beads were mixed with about 60 g of binder solution. These were mixed using a kitchen blender for about a minute, until good spread of the liquid over the beads was achieved. The wetted beads were then filled into a mould with a rectangular shape with a spatula. The samples were cured at 200° C. for 7 minutes. After cooling, the strength for breaking the samples was measured by a 3-point bending test. The DIN EN63 norm was used. Eventually the strength can also be tested after humid ageing, usually 16 hours at 50° C. and 80% relative humidity.

TABLE 1

| | | | | |
|---|---|---|---|---|
| Glass beads | 582 | 582 | 582 | 582 |
| Waterglass | 62 | 44 | 15 | 15 |
| Emulsifiable MDI | 6 | 6 | 16.2 | 16.2 |
| Water for emulsifying iso | 12 | 12 | 34 | 34 |
| % isocyanate | 1 | 1 | 2.7 | 2.7 |
| % waterglass solids | 2 | 2 | 0.3 | 0.3 |
| % total resin | 3 | 3 | 3 | 3 |
| Cure temperature | 200 | 200 | 200 | 200 |
| Component added first | waterglass | isocyanate | waterglass | isocyanate |
| Comments | 1% silane on solids | 1% silane on solids | 0.1% silane on solids | 0.1% silane on solids |
| | in water just before | in water just before | in water just before | in water just before |
| | adding isocyanate | adding isocyanate | adding isocyanate | adding isocyanate |
| Stress @ max load (kPa) | 4800 | 3500 | 2300 | 1400 |
| standard deviation | 800 | 600 | 800 | 500 |
| After humid ageing at 50° C. | | | | |
| and 80% R.H. for 16 h | | | | |
| Stress @ max load (kPa) | 4100 | 1700 | 600 | 800 |
| standard deviation | 490 | 500 | 140 | 200 |
| Strength loss (%) | 15% | 51% | 74% | 43% |

### EXAMPLE 3

A surprising advantage was found in the addition order of an adhesion promotor, an aminosilane. It was found that adding the silane in the water before emulsifying the MDI gives better strength, and in particular better strength retention after humid ageing. This is shown in the following table.

TABLE 2

| Formulation | A | A Repeated | B | B Repeated |
|---|---|---|---|---|
| Glass beads | 588 | 588 | 588 | 588 |
| emulsifiable MDI | 12 | 12 | 12 | 12 |
| Water | 48 | 48 | 48 | 48 |
| % isocyanide | 2 | 2 | 2 | 2 |
| Curing temperature | 200 | 200 | 200 | 200 |
| Comments | 1% silane on solids | 1% silane on solids | 1% silane on solids | 1% silane on solids |
| | in water BEFORE | in water BEFORE | in water AFTER | in water AFTER |
| | adding isocyanate | adding isocyanate | adding isocyanate | adding isocyanate |
| Stress @ max load | 6000 | 6600 | 5900 | 5300 |
| (kPa) | | | | |
| standard deviation | 700 | 900 | 700 | 700 |
| after humid ageing at 50° C. | | | | |
| and 80% R.H. for 16 h | | | | |
| Stress @ max load | 3200 | 5600 | 1000 | 950 |
| (kPa) | | | | |
| standard deviation | 300 | 1000 | 200 | 130 |
| Strenght loss (%) | 47% | 15% | 83% | 82% |

1. A binder for binding mineral fibers comprising an organic polyisocyanate and an alkali metal silicate.

2. The binder according to claim 1 wherein the alkali metal silicate is a sodium silicate having a SiO₂:Na₂O molar ratio from 1.6:1 to 3.5:1.

3. The binder according to claim 1 wherein the alkali metal silicate is used in the form of an aqueous solution.

4. The binder according to claim 3 wherein the solids content of the aqueous solution is between 5 and 15 wt %.

5. The binder according to claim 1 wherein the polyisocyanate is used in the form of an aqueous solution.

6. The binder according to claim 5 wherein the polyisocyanate is an aromatic liquid polyisocyanate.

7. The binder according to claim 6 wherein the polyisocyanate is diphenylmethane diisocyanate or a derivative thereof.

8. The binder according to claim 5 wherein the polyisocyanate is a prepolymer having an average functionality of 2 to 2.9, a maximum viscosity of 6000 mPa s, and an isocyanate content of 6 to 31.5 wt %.

9. The binder according claim 8 wherein the polyisocyanate is emulsifiable.

10. The binder according to claim 1 wherein the weight ratio between polyisocyanate and alkali metal silicate is between 95:5 and 20:80.

11. The binder according to claim 1 further comprising an amino-containing silane.

12. (canceled)

13. A process for preparing a reaction mixture comprising preparing an aqueous emulsion of an organic polyisocyanate and preparing an aqueous solution of alkali metal silicate thereto.

14. The process according to claim 13 including preparing a solution of a silane in water, and adding the polyisocyanate to the solution of silane in water.

15. (canceled)

16. A process for providing a bound mineral fiber product, comprising:
administering a binder comprising an organic polyisocyanate and an alkali metal silicate to mineral fibers; and
curing the binder.

17. The process according to claim 16 including separately applying the polyisocyanate and the alkali metal silicate to the mineral fibers.

18. The process according to claim 17 wherein separately applying the polyisocyanate and the alkali metal silicate includes applying the alkali metal silicate before applying the polyisocyanate.

19. The process according to claim 16 wherein curing the binder includes curing the binder without applying additional heating.

20. (canceled)

21. The binder according to claim 8 wherein the polyisocyanate is a prepolymer having an average functionality of 2.1 to 2.7.

22. The binder according to claim 10 wherein the weight ratio between polyisocyanate and alkali metal silicate is between 85:15 and 50:50
